(19) United States
(12) Patent Application Publication
(10) Pub. No.: US 2024/0420335 A1
(43) Pub. Date: Dec. 19, 2024

(54) Systems and Methods for Video Encoding and Segmentation

(71) Applicant: Comcast Cable Communications, LLC, Philadelphia, PA (US)

(72) Inventors: Md Mahmudul Hasan, Arlington, VA (US); Md Mohaiminul Islam, Raleigh, NC (US); Kishan Shamsundar Athrey, Chicago, IL (US); Anthony J. Braskich, Kildeer, IL (US)

(21) Appl. No.: 18/336,596

(22) Filed: Jun. 16, 2023

(51) Int. Cl. G06T 7/11; G06T 7/70; G06V 10/25; G06V 10/74; H04N 23/67

(52) U.S. Cl. CPC G06T 7/11; G06T 7/70; G06V 10/25; G06V 10/761; H04N 23/675

(57) ABSTRACT

Systems, apparatuses, and methods are described for segmenting a video content item (e.g., movie, TV-show) into a collection of scenes. Video frames may be grouped into shots, and visual relationships between image portions within each shot are identified by a self-attention model. The output may be further processed by a gated state space model to identify visual relationships between features in different shots. Multiple instances of the self-attention model and the gated state space model may be used to focus on different aspects of the video content item, for finding the relationships. An aggregated output may be provided to a prediction model and processed by the prediction model to determine scene boundaries. The determined scene boundaries or segmented scenes may be used for various user applications such as ad insertion, chapter selection, content searching, browsing, etc.

### BACKGROUND

Users often have favorite scenes in movies, and they may find it helpful to be able to see a listing of scenes in the movie, and to quickly jump to a particular scene that they wish to watch. However, supporting such a feature can be difficult, as it can be time-consuming to prepare information indicating where particular scenes begin and end. Furthermore, after a movie is processed to identify boundaries where particular types of scenes begin, it can be time consuming to add identification of a new kind of scene boundary if it was not included in the initial processing of the movie.

### SUMMARY

The following summary presents a simplified summary of certain features. The summary is not an extensive overview and is not intended to identify key or critical elements.

Systems, apparatuses, and methods are described for segmenting a video content item (e.g., movie, TV-show) into a collection of scenes. The video may be processed to identify camera shots—or groups of consecutive video frames that appear to have been captured by the same camera. The shots may be supplied to (or applied with) a self-attention model (“first model”), which may process the shot frames and identify relationships between portions of the frames in each shot. These relationships refer to the spatial relationships between different portions, which could be related to their positions, shapes, sizes, orientations, or other visual properties. Relationship strength may be based on spatial proximity and/or visual similarity. For example, two portions in an image may have a stronger relationship if they are close to each other, compared to if they are far apart from each other. For another example, two portions in an image may have a stronger relationship if they have similar shapes or textures. The self-attention mechanism may give each portion a weight based on the portion's relationship with other portions, to indicate the relationship strength. The output of the self-attention model may contain a weighted combination of the recognized features from all portions of an image, and may be provided to a gated state space model (“second model”) and processed by the gated state space model to identify relationships between frames of different shots. The gated state-space model may identify relationships between features in frames of different shots, for example, visual similarities between recognized objects from different shots, temporal cues such as actions, events, or activities that occur over time, etc. The output of the gated state space model may contain information about relationships between different shots, for example, how similar or connected one shot is with its neighboring shots. The output of the gated state space model may be provided to a prediction model and processed by the prediction model to determine which shots belong together in a scene and the corresponding boundaries between different scenes.

Multiple instances of the self-attention model and the gated state space model (“model pairs”) may be used to focus on different aspects of the video content item, for finding the relationships. For example, one instance may be used to focus on human faces (e.g., looking for faces within a shot's frames, or similar faces to appear in frames of different shots), while another instance may be used to focus on background images (e.g., looking for similar background features, such as trees, room furnishings, etc.). These instances may be stacked in series, such that the output of one may be provided as input to the next.

The determined scene boundaries or segmented scenes may be used for various user applications such as ad insertion, chapter selection, content searching, browsing, etc. The segmented scenes may be categorized based on their content. Categories of these segmented scenes may be used for identifying recommended scene boundaries for ad insertion.

These and other features and advantages are described in greater detail below.

### BRIEF DESCRIPTION OF THE DRAWINGS

Some features are shown by way of example, and not by limitation, in the accompanying drawings. In the drawings, like numerals reference similar elements.

FIG. 1 shows an example communication network.

FIG. 2 shows hardware elements of a computing device.

FIG. 3 shows an example movie with example frames, shots, and scenes.

FIG. 4A shows an overview of an example process for determining scene boundaries.

FIG. 4B shows details of an example S4A block.

FIG. 4C shows an example series of stacked S4A blocks.

FIG. 5 shows example applications for segmented scenes.

FIG. 6A is a flow chart showing an example method for segmenting scenes.

FIG. 6B is a flow chart mainly showing an example method for using segmented scenes.

FIG. 7A and FIG. 7B show example interfaces for presenting recommended scenes for ad insertion.

### DETAILED DESCRIPTION

The accompanying drawings, which form a part hereof, show examples of the disclosure. It is to be understood that the examples shown in the drawings and/or discussed herein are non-exclusive and that there are other examples of how the disclosure may be practiced.

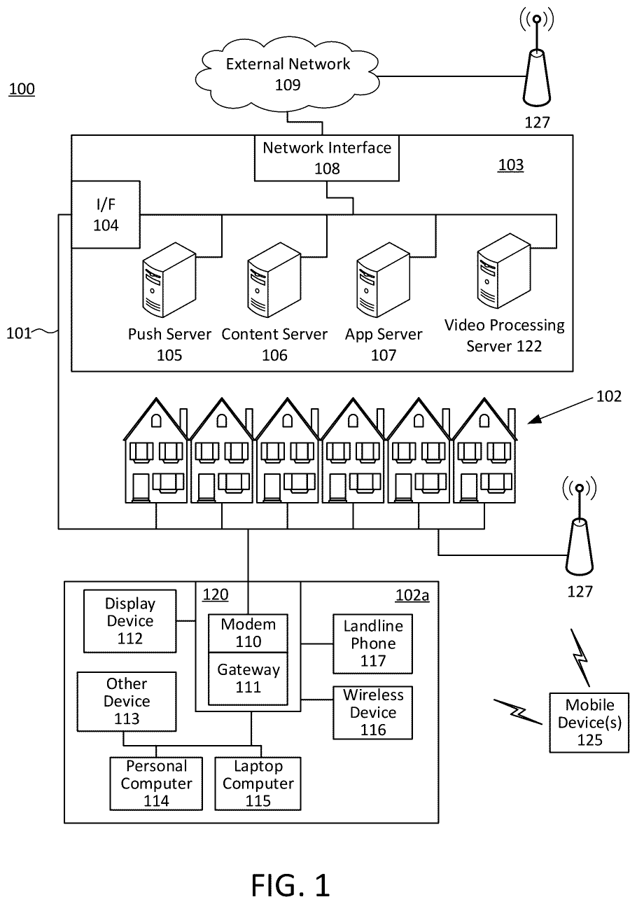

FIG. 1 shows an example communication network 100 in which features described herein may be implemented. The communication network 100 may comprise one or more information distribution networks of any type, such as, without limitation, a telephone network, a wireless network (e.g., an LTE network, a 5G network, a WiFi IEEE 802.11 network, a WiMAX network, a satellite network, and/or any other network for wireless communication), an optical fiber network, a coaxial cable network, and/or a hybrid fiber/coax distribution network. The communication network 100 may use a series of interconnected communication links 101 (e.g., coaxial cables, optical fibers, wireless links, etc.) to connect multiple premises 102 (e.g., businesses, homes, consumer dwellings, train stations, airports, etc.) to a local office 103 (e.g., a headend). The local office 103 may send downstream information signals and receive upstream information signals via the communication links 101. Each of the premises 102 may comprise devices, described below, to receive, send, and/or otherwise process those signals and information contained therein.

The communication links 101 may originate from the local office 103 and may comprise components not shown, such as splitters, filters, amplifiers, etc., to help convey signals clearly. The communication links 101 may be coupled to one or more wireless access points 127 configured to communicate with one or more mobile devices 125 via one or more wireless networks. The mobile devices 125 may comprise smart phones, tablets or laptop computers with wireless transceivers, tablets or laptop computers communicatively coupled to other devices with wireless transceivers, and/or any other type of device configured to communicate via a wireless network.

The local office 103 may comprise an interface 104. The interface 104 may comprise one or more computing devices configured to send information downstream to, and to receive information upstream from, devices communicating with the local office 103 via the communications links 101. The interface 104 may be configured to manage communications among those devices, to manage communications between those devices and backend devices such as servers 105-107 and 122, and/or to manage communications between those devices and one or more external networks 109. The interface 104 may, for example, comprise one or more routers, one or more base stations, one or more optical line terminals (OLTs), one or more termination systems (e.g., a modular cable modem termination system (M-CMTS) or an integrated cable modem termination system (I-CMTS)), one or more digital subscriber line access modules (DSLAMs), and/or any other computing device(s). The local office 103 may comprise one or more network interfaces 108 that comprise circuitry needed to communicate via the external networks 109. The external networks 109 may comprise networks of Internet devices, telephone networks, wireless networks, wired networks, fiber optic networks, and/or any other desired network. The local office 103 may also or alternatively communicate with the mobile devices 125 via the interface 108 and one or more of the external networks 109, e.g., via one or more of the wireless access points 127.

The push notification server 105 may be configured to generate push notifications to deliver information to devices in the premises 102 and/or to the mobile devices 125. The content server 106 may be configured to provide content to devices in the premises 102 and/or to the mobile devices 125. This content may comprise, for example, video, audio, text, web pages, images, files, etc. The content server 106 (or, alternatively, an authentication server) may comprise software to validate user identities and entitlements, to locate and retrieve requested content, and/or to initiate delivery (e.g., streaming) of the content. The application server 107 may be configured to offer any desired service. For example, an application server may be responsible for collecting, and generating a download of, information for electronic program guide listings. Another application server may be responsible for monitoring user viewing habits and collecting information from that monitoring for use in selecting advertisements. Yet another application server may be responsible for formatting and inserting advertisements in a video stream being transmitted to devices in the premises 102 and/or to the mobile devices 125. The local office 103 may comprise additional servers, such as the video processing server 122 (described below), additional push, content, and/or application servers, and/or other types of servers. The video processing server 122 may be configured to process videos (e.g., movies, TV shows), for example, before they go to an application server for advertisement insertion. For example, the video processing server 122 may perform scene segmentation in the videos as described herein. Although shown separately, the push server 105, the content server 106, the application server 107, the video processing server 122, and/or other server(s) may be combined. The servers 105, 106, 107, and 122, and/or other servers, may be computing devices and may comprise memory storing data and also storing computer executable instructions that, when executed by one or more processors, cause the server(s) to perform steps described herein.

An example premises 102a may comprise an interface 120. The interface 120 may comprise circuitry used to communicate via the communication links 101. The interface 120 may comprise a modem 110, which may comprise transmitters and receivers used to communicate via the communication links 101 with the local office 103. The modem 110 may comprise, for example, a coaxial cable modem (for coaxial cable lines of the communication links 101), a fiber interface node (for fiber optic lines of the communication links 101), twisted-pair telephone modem, a wireless transceiver, and/or any other desired modem device. One modem is shown in FIG. 1, but a plurality of modems operating in parallel may be implemented within the interface 120. The interface 120 may comprise a gateway 111. The modem 110 may be connected to, or be a part of, the gateway 111. The gateway 111 may be a computing device that communicates with the modem(s) 110 to allow one or more other devices in the premises 102a to communicate with the local office 103 and/or with other devices beyond the local office 103 (e.g., via the local office 103 and the external network(s) 109). The gateway 111 may comprise a set-top box (STB), digital video recorder (DVR), a digital transport adapter (DTA), a computer server, and/or any other desired computing device.

The gateway 111 may also comprise one or more local network interfaces to communicate, via one or more local networks, with devices in the premises 102a. Such devices may comprise, e.g., display devices 112 (e.g., televisions), other devices 113 (e.g., a DVR or STB), personal computers 114, laptop computers 115, wireless devices 116 (e.g., wireless routers, wireless laptops, notebooks, tablets and netbooks, cordless phones (e.g., Digital Enhanced Cordless Telephone—DECT phones), mobile phones, mobile televisions, personal digital assistants (PDA)), landline phones 117 (e.g., Voice over Internet Protocol—VoIP phones), and any other desired devices. Example types of local networks comprise Multimedia Over Coax Alliance (MoCA) networks, Ethernet networks, networks communicating via Universal Serial Bus (USB) interfaces, wireless networks (e.g., IEEE 802.11, IEEE 802.15, Bluetooth), networks communicating via in-premises power lines, and others. The lines connecting the interface 120 with the other devices in the premises 102a may represent wired or wireless connections, as may be appropriate for the type of local network used. One or more of the devices at the premises 102a may be configured to provide wireless communications channels (e.g., IEEE 802.11 channels) to communicate with one or more of the mobile devices 125, which may be on- or off-premises.

The mobile devices 125, one or more of the devices in the premises 102a, and/or other devices may receive, store, output, and/or otherwise use assets. An asset may comprise a video, a game, one or more images, software, audio, text, webpage(s), and/or other content.

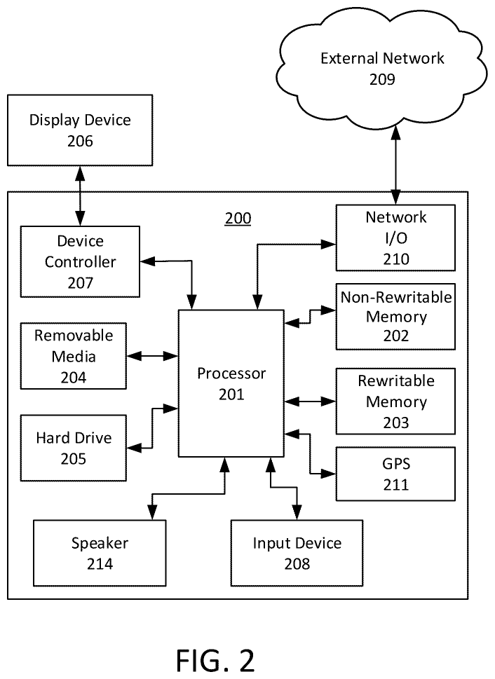

FIG. 2 shows hardware elements of a computing device 200 that may be used to implement any of the computing devices shown in FIG. 1 (e.g., the mobile devices 125, any of the devices shown in the premises 102a, any of the devices shown in the local office 103, any of the wireless access points 127, any devices with the external network 109) and any other computing devices discussed herein. The computing device 200 may comprise one or more processors 201, which may execute instructions of a computer program to perform any of the functions described herein. The instructions may be stored in a non-rewritable memory 202 such as a read-only memory (ROM), a rewritable memory 203 such as random access memory (RAM) and/or flash memory, removable media 204 (e.g., a USB drive, a compact disk (CD), a digital versatile disk (DVD)), and/or in any other type of computer-readable storage medium or memory. Instructions may also be stored in an attached (or internal) hard drive 205 or other types of storage media. The computing device 200 may comprise one or more output devices, such as a display device 206 (e.g., an external television and/or other external or internal display device) and a speaker 214, and may comprise one or more output device controllers 207, such as a video processor or a controller for an infra-red or BLUETOOTH transceiver. One or more user input devices 208 may comprise a remote control, a keyboard, a mouse, a touch screen (which may be integrated with the display device 206), microphone, etc. The computing device 200 may also comprise one or more network interfaces, such as a network input/output (I/O) interface 210 (e.g., a network card) to communicate with an external network 209. The network I/O interface 210 may be a wired interface (e.g., electrical, RF (via coax), optical (via fiber)), a wireless interface, or a combination of the two. The network I/O interface 210 may comprise a modem configured to communicate via the external network 209. The external network 209 may comprise the communication links 101 discussed above, the external network 109, an in-home network, a network provider's wireless, coaxial, fiber, or hybrid fiber/coaxial distribution system (e.g., a DOCSIS network), or any other desired network. The computing device 200 may comprise a location-detecting device, such as a global positioning system (GPS) microprocessor 211, which may be configured to receive and process global positioning signals and determine, with possible assistance from an external server and antenna, a geographic position of the computing device 200.

Although FIG. 2 shows an example hardware configuration, one or more of the elements of the computing device 200 may be implemented as software or a combination of hardware and software. Modifications may be made to add, remove, combine, divide, etc. components of the computing device 200. Additionally, the elements shown in FIG. 2 may be implemented using basic computing devices and components that have been configured to perform operations such as are described herein. For example, a memory of the computing device 200 may store computer-executable instructions that, when executed by the processor 201 and/or one or more other processors of the computing device 200, cause the computing device 200 to perform one, some, or all of the operations described herein. Such memory and processor(s) may also or alternatively be implemented through one or more Integrated Circuits (ICs). An IC may be, for example, a microprocessor that accesses programming instructions or other data stored in a ROM and/or hardwired into the IC. For example, an IC may comprise an Application Specific Integrated Circuit (ASIC) having gates and/or other logic dedicated to the calculations and other operations described herein. An IC may perform some operations based on execution of programming instructions read from ROM or RAM, with other operations hardwired into gates or other logic. Further, an IC may be configured to output image data to a display buffer.

Features herein may provide a computerized approach to processing video content to identify boundaries where scenes begin and/or end, to allow users to quickly find and watch scenes of interest. The computerized approach may involve grouping sequential video frames into shots, and then processing the video frames on a shot-by-shot basis, to identify intra-shot relationships (e.g., positions, shapes, sizes, orientations, or other visual properties) between images of frames within a same shot, and to identify inter-shot relationships (e.g., similarities, and/or temporal cues such as actions, events, or activities that occur over time, etc.) between images of frames that belong to different shots. The intra-shot relationships may be identified using a self-attention learning model, and the inter-shot relationships may be identified using a gated state-space model. These intra-shot and inter-shot relationships may then be processed by a prediction model to group the shots into scenes—to determine which shots belong together in a same scene, and which shots are of different scenes.

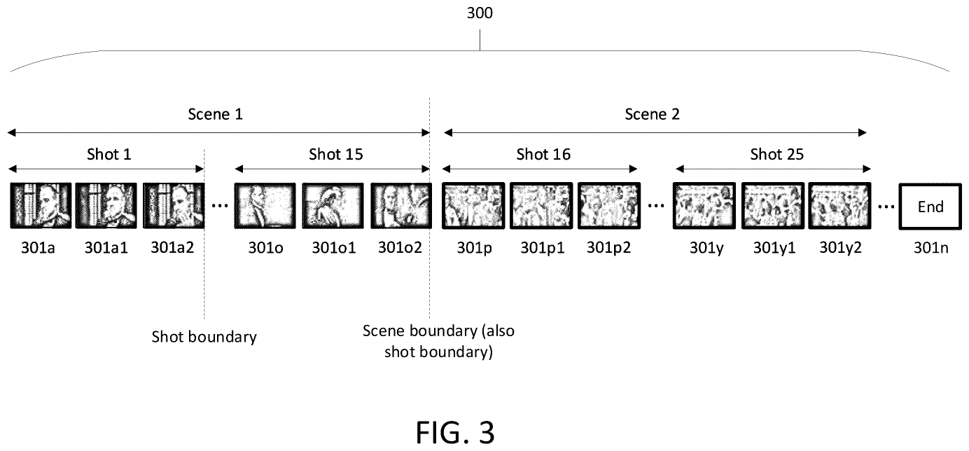

The process will be explained by way of the example movie 300 shown in FIG. 3. A primary content item such as a movie 300 may comprise a sequence of video frames 301a-n of a plurality of scenes. For example, the movie 300 may begin with Scene 1, in which a main character has a conversation with a supporting character, and may then proceed to Scene 2, in which the main character attends a wedding. Each of these scenes may have been filmed using one or more cameras, and the scenes may comprise one or more camera shots. A camera shot may comprise a sequence of video frames that appear to have been captured by a same camera (either stationary or moving), and will generally have many visual similarities. In the example movie 300, an opening Shot 1 may comprise several seconds of video in which the main character is introduced with a close-up view of his face. A later shot, Shot 15, may show that main character having a conversation with a friend. The next shot, Shot 16, may begin a new scene in which the main character attends a wedding, and the wedding scene may continue through Shot 25. As will be explained below, the scene boundaries (e.g., point in the movie where one scene ends and another scene begins; two consecutive frames that belong to different scenes; or a division between groupings of frames belonging to different scenes, etc.) may be determined by examining the video frames on a shot-by-shot basis to determine: 1) intra-shot similarities between frames of a same shot (and/or dependencies between portions of a single frame in the shot), and 2) inter-shot similarities and/or temporal cues between frames of different shots. Those relationships (e.g., similarities) may then be provided to a prediction model, which can determine the scene boundaries.

A self-attention module may be used to identify the intra-shot similarities and/or dependencies. Self-attention is good at identifying features based on relationships (e.g., similarities, differences, etc.) between image portions of each shot. A gated state space module may be used to determine inter-shot similarities. The combined use of these two modules and multiple layers of such modules bring encoding outputs for each shot in a comprehensive and cost-effective way. And each of the encoded shots has contextual information (e.g., relationship with adjacent shots, story sequence among neighboring shots, etc.) besides in-shot features, which provides a more accurate basis for scene boundary determination at the prediction model.

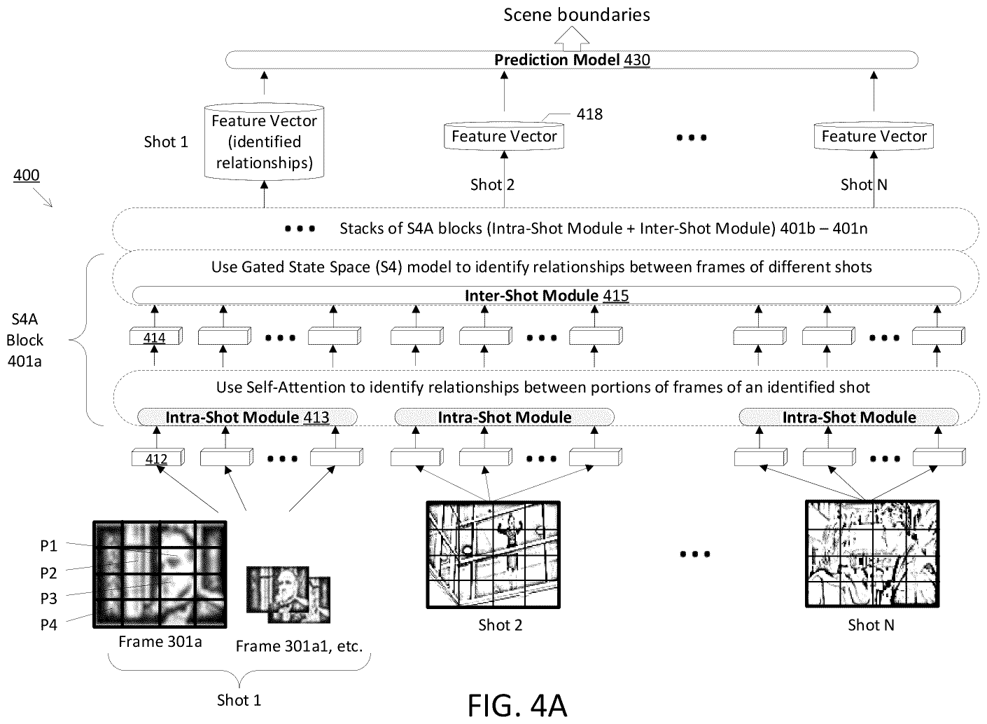

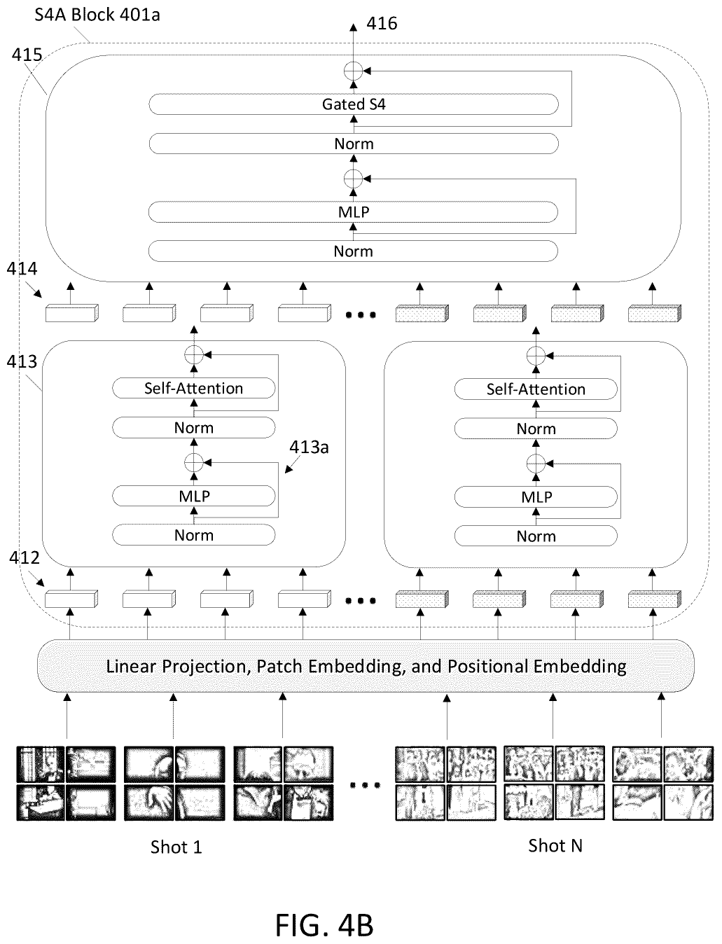

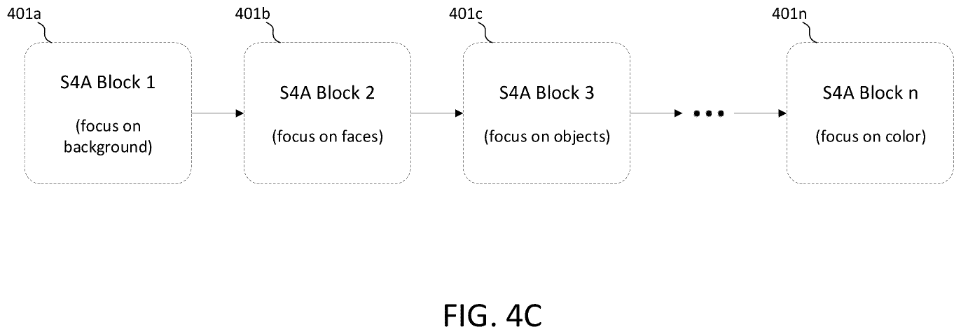

FIG. 4A shows an overview of an example process for determining scene boundaries in a video content item (or primary content item), such as the movie 300, using a contextual shot encoder 400 and a prediction model 430. As will be described, the various frames of the movie 300 may first be processed to group the frames into shots by identifying shot boundaries. Then, the images in the shots may be processed to determine which shot boundaries should also be considered scene boundaries. These scene boundaries may then be used to divide the movie 300 into different scenes. Starting at the bottom of FIG. 4A, the various frames of at least part of the movie 300 may be processed to identify the different shots. Frames belonging to a same shot may generally have a large degree of visual similarity. For example, in the Shot 1 frames, the main character's face can be found in each of the frames, although it may be in a slightly different position in each frame. Consecutive frames may be compared for visual similarities, such as identifying a face that appears in both frames. If consecutive frames have similar features (e.g., enough similarities to satisfy a threshold) and/or otherwise show the same camera angle, distance, focus, etc., then the consecutive frames may be deemed to be part of a same shot. If, however, consecutive frames are quite different, then it may be determined that a shot boundary exists between the consecutive shots. For example, in movie 300, frames 301o1 and 301o2 are quite similar as they both have a similar view of the clothing of the main character and his friend, so an image comparison between the two frames 301o1 and 301o2 may yield a high degree of similarity. But frames 301o2 and 301p are quite different because, although the main character and his friend appear in frame 301o2, a similar image of the two characters is not found in the next frame 301p. So an image comparison of frames 301o2 and 301p may yield a low degree of similarity, and this low degree of similarity (or high degree of difference) may result in a determination that a shot boundary exists between frames 301o2 and 301p.

After the shots are identified, each shot may be processed by an intra-shot module 413, to examine the frames of each shot to identify visual relationships (e.g., similarities) within the frames of each shot. The identified visual relationships within each shot may be used for identifying visual relationships between different shots, which may be used to determine which shot boundaries should also be classified as scene boundaries, as will be described later. FIG. 4A illustrates separate intra-shot modules 413, one for each shot, but this is just for ease of explanation.

The intra-shot module 413 may compare each frame, or portion of a frame, with other frames and/or frame portions within the same shot, and may identify visual similarities. For example, the intra-shot module 413 may determine that some portions (e.g., portions P1 and P3 in FIG. 4A) within frame 301a have similar colors. The intra-shot module 413 may determine that frames 301a and 301al, both within Shot 1, have a visual pattern of the main character's face. The intra-shot module 413 may also determine that these frames 301a and 301al also have similar background features, such as the wallpaper behind the main character, the main character's clothing, etc. The intra-shot module 413 may also determine differences in these frames, such as the different position of the main character's face, or that a feature is found in one frame (of Shot 1) but not another frame (of Shot 1).

The intra-shot module 413 may employ a self-attention learning model to identify the visual similarities discussed above. As illustrated in FIG. 4A, each frame may be subdivided into portions. This may help a self-attention mechanism in the self-attention learning model to analyze the relationships within the frames and extract (or identify) the features (e.g., object, person) in a more accurate way. The self-attention mechanism may pay different attention (e.g., give different attention weights) to different image portions (or regions), based on the relationships or dependencies between the portions. For example, frame 301a of Shot 1 in FIG. 4A may be divided to 16 non-overlapping patches. These patches may be similar in shape and size, and may be generated by, for example, evenly dividing a rectangular frame 301a in both length and width directions. These patches or image portions may comprise a man's face, shoulder, clothing, and/or background objects (wall, shades, etc.). A trained self-attention mechanism may recognize similar portions and may assign more weights to adjacent and similar image portions within a frame. For example, as shown in FIG. 4A, adjacent image portions P1 and P3 have similar textures and are recognized as both belonging to a person's face. Adjacent image portions P1 and P2 do not have similar textures or shapes, and P2 is recognized as a background object. Image portion P4 is not adjacent or similar to any one of portions P1, P2, and P3, and is recognized as a background object. Among the image portions P1 to P4, P1 and P3 may have the highest weights, as they are adjacent and both relate to a person's face; P2 may have the third highest weight, as it is adjacent to P1; and P4, which is associated with a distant background object, may have the lowest weight. With different attention weights among the image portions, different features (e.g., object, person) may be more easily extracted (or recognized) by a trained self-attention mechanism. Similarly, when comparing different frames of the same shot, different attention weights may be assigned to image portions and may be used to evaluate similarities and/or differences between the frames.

As illustrated, the intra-shot module 413 may be provided with embedding vectors 412, which may indicate a mathematical representation of the image portions of a frame as mentioned above. The self-attention mechanism does not work with 2D images directly. It may need a mathematical input that represent the images. A vector may be an ordered list of numbers with respect to a chosen basis. For example, the image portions (may be called patches) of a frame may be projected onto a lower-dimensional subspace (may be called linear projection) to generate a sequence of numbers that represent the image portions and capture the information and/or structure of the image portions (may be called patch embedding). For example, the shape and texture (e.g., color, intensity) of a man's face in an image portion (e.g., portion P1) may be described using numbers specified in a specific application for image recognition. These sequence of numbers may also be added with a sequence of numbers that represent positional relationships between the image portions (may be called position embedding or positional embedding). The resulted sequence of numbers (with both patch embedding and position embedding) may be called embedding vectors. The process of generating embedding vectors may be performed for each of the frames in a shot and by any known applications or mechanisms in this field. These embedding vectors 412 generated from the frames may be inputted to the intra-shot module 413 for identifying visual similarities and different weights as described above.

The intra-shot module 413 may generate output data 414 indicating extracted features (e.g., object, person) for each shot. The output data 414 may take various forms. For example, the data may comprise indication that Shot 1 contains a man with facial features such as a longitudinal face, a protruding forehead, dark eyes, etc. The data may also indicate that Shot 1 has a background with shades on a window and walls beside the window. The output data 414 may be expressed as a tensor, for example, a 2D tensor. A tensor is like a container which can house data in N dimensions. The 2D tensor has two dimensions and may be called a matrix. The two-dimensional matrix may contain a rectangular array of numbers and may be similar to a heatmap where each number represents the attention weight assigned to a corresponding spatial location (e.g., a specific image portion of a frame). As described above, the attention weights may represent relevancy (e.g. similarity) and adjacency with respect to a focus (e.g., a human face, an object, etc.). The attention weight matrix may look something like this:
[[0.8, 0.1, 0.05, 0.05],
[0.2, 0.7, 0.05, 0.05],
[0.1, 0.05, 0.8, 0.05],
[0.1, 0.05, 0.05, 0.8]].

The matrix may also contain data from the embedding vectors 412. Such matrix may be called an attention map. The self-attention mechanism may generate more than one attention map for each shot. For example, for Shot 1, there may be one attention map for the specific feature: the main character. In this example, the attention map may use different weights to highlight the image portions that are most relevant for the presence of the main character, such as the face and clothing of the main character, while suppressing less relevant image portions such as the background. For example, the main character portions may be given higher weights, and the background portions may be given lower weights. There may be another attention map for the specific feature: the background. In this example, the attention map may highlight image portions that are most relevant for the background objects and suppress less relevant image portions such as the main character, by giving higher weights to the background portions and lower weights to the main character portions. There may be further attention maps focusing on more detailed features such as the nose. These maps may be generated by more than one self-attention model. For example, a first self-attention model may generate an attention map focusing on a person, and a second self-attention model may generate another attention map focusing on the background. With a set of attention maps focusing on different features, each shot may be accurately interpreted and represented, which makes further comparison between shots more accurate and comprehensive, as will be described below.

The output data 414 may be provided to an inter-shot module 415. The inter-shot module 415 may process the output data 414 to identify relationships (e.g., similarities, temporal cues) between frames that are in different shots. These similarities, temporal cues (e.g., actions, events, or activities that occur over time), etc. may be added (e.g., as additional numbers) to data describing each shot (e.g., output data 414), and the resulted data 418 may be used by a trained prediction model 430 to determine scene boundaries. For example, the trained prediction model 430 may deem two shots to be part of a same scene, if frames of the two shots include a threshold quantity of similarities. Using the FIG. 3 example, frames 301a and 301o may be from different shots (Shots 1 and 15), but the side-view of the main character in frame 301o may be deemed to be similar enough to the front-view of the main character in frame 301a. Also, frames 301a and 301o may have a similar background. Thus, Shot 1 and Shot 15 may be considered as part of a same scene. Frames 301o2 and 301p do not have the same or similar characters or background, and may be deemed as not part of a same scene. For example, a set of consecutive shots may show different characters, but may have consistency in the background (e.g., similar colors, structures). These shots may be deemed as in the same scene. For another example, a set of consecutive shots may comprise first shots showing a person talking on a phone in a background and second shots showing another person talking on a phone in another background, and the first shots alternate with the second shots. These consecutive shots may indicate a temporal cue (e.g., phone-call activity that occurs over time) and may be deemed as in the same scene. For another example, a set of consecutive shots may indicate that a person is running. This temporal cue (e.g., running action) may make these consecutive shots belong to the same scene. Determination for scene boundaries based on the similarities and temporal cues may be learned through training a machine learning model. The prediction model 430 may be an existing boundary prediction model such as a pseudo-boundary prediction model.

The inter-shot module 415 may be implemented as a gated state-space (S4) model, which is a machine learning model. The gated S4 model is good at making long-span comparisons to extract or identify connections that evolve over time. A gating mechanism in the gated S4 model may selectively choose which information to keep and which to discard at each time step, making it effective in capturing long-term dependencies. Using the FIG. 3 example, the gated S4 model may select Shots 1 to 16 and identify the evolvement of the main character. The gated S4 model may focus on the features of the main character and discard features that are not relevant to the main character (e.g., the background, the other character, etc.). For example, the gated S4 model may keep the features (e.g., face, shoulder, clothing) of the main character in Shot 1 and detect new features (e.g., hand) of the main character in Shot 2 (not shown). The gated S4 model may detect the main character missing in Shot 14 (not shown), and find it reappearing in Shot 15 and missing again in Shot 16. The gated S4 model may identify, for Shots 1 to 16, visual consistency and change of the main character over time. Similarly, the gated S4 model may focus on a background object and identify an evolvement (e.g., visual consistency and change over time) of that object over Shots 1 to 16. These inter-shot connections (or relationships, dependencies) may be captured in a mathematical form for each shot. For example, a trained gated S4 model may output numbers of probabilities indicating the likelihood of an input sequence (e.g., consecutive shots) belonging to a class or an action. The output may look something like:
[0.3, 0.5, 0.7, 0.05, 0.05].

For example, the action may be “Running”, and the output numbers may indicate that the first three shots have higher probabilities of “Running”, compared to the last two shots. These output numbers may be added to the output data 414. Similar to the self-attention mechanism, the gated S4 model may work with processed image data such as embedding vectors 412. However, it may be more efficient and accurate for the gated S4 model to work with output data 414 generated by the intra-shot module 413 (i.e., the self-attention mechanism), as the output data 414 contain meaningful features extracted (or identified) by the self-attention mechanism. For example, embedding vectors 412 may describe basic features throughout an image, such as lines, colors, intensity, and the intra-shot module 413 may process the information to determine the meanings of these features (e.g., which features form a person, which features form an object, etc.). The gated S4 model may identify visual relationships and temporal cues between different shots, based on these features with meanings. The gated S4 model is an efficient model with a less computation cost as compared to the self-attention mechanism, and is thus more cost-efficient in making long-span comparisons as described above, while the self-attention mechanism is better at identifying meaningful features.

The intra-shot module 413 and inter-shot module 415 as described above together are called a S4A block (or a model pair) 401a, indicating a combination of a gated S4 model (“S4”) and a self-attention model (“A”). A plurality of such blocks may be arranged in series and used for extracting (or identifying) more detailed features and/or relationships. Each block may have a different focus, and their results may be considered stacked. For example, FIG. 4C shows n number of similar S4A blocks 401a, 401b, 401c, . . . 401n. For example, one block 401b may be logic (e.g., software and/or hardware) configured to examine the frames looking for human faces, and may try to find similar faces in the frames being processed. Other blocks may be focused on finding other kinds of similarities, such as similarities in color palettes, similarities in background patterns, similarities in recognizable objects (e.g., recognizing predetermined shapes such as cars, wheels, animals, etc.).

Also, while it is possible for the intra-shot module 413 and inter-shot module 415 to process every frame of every shot, it may be desirable to reduce the number of frames that are actually processed. Such a reduction may help to preserve processing resources and/or electrical power. The reduction can be done in a variety of ways. For example, if the content item is encoded using motion-based encoding in which frames are organized as groups of pictures (GOPs), with each GOP having an independent frame and one or more dependent frames that are encoded with respect to the independent frame, then the modules may be configured to only process the independent frames. The reduction may also, or alternatively, be based on time. For example, the modules may be configured to process one frame for every 2 seconds of video. Any desired subset configuration may be used, and may be optimized to provide a desired balance between processing demands and scene segmentation accuracy.

FIG. 4B shows details of an example S4A block 401a. An S4A block (e.g., S4A block 401a) may comprise the intra-shot module 413 and the inter-shot module 415, as described above. A block and a module may be logical processes implemented by the computing device 200 and may carry out at least part of the method steps, for example, as shown in the algorithm figures. The module may carry out a subset of the method steps as carried out by the block. The intra-shot module 413 may comprise the self-attention model, and the inter-shot module 415 may comprise the gated S4 model. Besides those models as described above, each module may comprise supplemental processes (called layers) to assist the performance of the models. These layers may comprise normalization layer and multi-layer perceptron (MLP) layer, which will be described in detail below.

In FIG. 4B, “Norm” represents the normalization layer. “NLP” represents the multi-layer perceptron layer, and the arrowed loops 413a represent residual connection. These terms will be explained below. The normalization layer is a process that normalizes input data and mitigates the effect of any outliers or extreme values in the data. For example, the input data may be embedding vectors 412 which were generated from divided image portions (or patches) of one or more frames of each shot, as described with respect to FIG. 4A. An extreme value in the embedding vectors 412 may be a very large or very small value that is significantly different from the other values in the vectors. For example, if a patch contains a very bright pixel surrounded by much darker pixels, the value of that pixel may be much larger than the values of the surrounding pixels. Similarly, if a patch contains a very dark pixel surrounded by much brighter pixels, the value of that pixel may be much smaller than the values of the surrounding pixels. Such extreme values may make it difficult for a machine learning model such as the self-attention model to learn the correct weights. For example, if the embedding vectors for a patch contain both very large and very small values, the self-attention model may become unstable in computation and may produce inferior results. Therefore, it may be important to mitigate the effect of extreme values. The process of normalization may contain steps of mathematical calculation and is well-known in this field. Detailed description on the mathematical calculation is omitted herein.

The MLP layer is a process to recognize patterns etc. in the input data. The MLP layer may provide further information to assist the self-attention model or gated S4 model. For example, the MLP layer may determine that there might be a person in the frame 301a in FIG. 3 and may add a label to the input data. The label may be in the form of a probability number and may be used to inform the self-attention model or gated S4 model of what might be in the image and provide focus for their processes. For example, if the label indicates a high probability of a person in an image, the self-attention model may focus on the person in a self-attention process and identify areas of attention based on this focus. The self-attention model may capture features about the person in a way described above. If there is also a label indicating a high probability for window, the self-attention model may focus on the window in another process. The MLP layer can be trained to perform the determination with certain accuracy. For example, the MLP layer may be trained by using a large quantity of examples of images with known labels and allow it to adjust its decision-making process.

There are also several arrowed loops 413a in FIG. 4B. These arrowed loops 413a represent residual connection which indicates skipping over (or bypassing) the MLP layer or the self-attention model or the gated S4 model and preserving the information from the input data. With residual connection, the intra-shot module 413 and the inter-shot module 415 in each S4A block may add newly recognized features and/or relationships (e.g., visual similarities, dependencies, temporal cues, etc.) to the original input data (e.g., embedding vectors 412), increasingly enriching the information in the output data (e.g., output data 414, 416), without losing the information in the original input data, and each S4A block may have different focus (see e.g., FIG. 4C) based on output data from the previous S4A block.

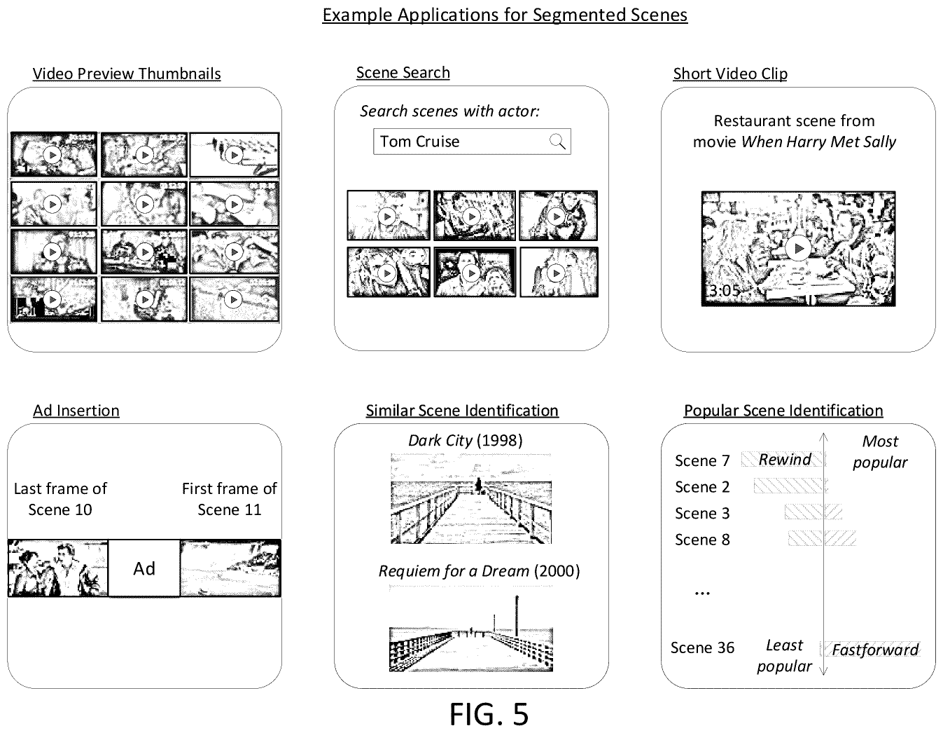

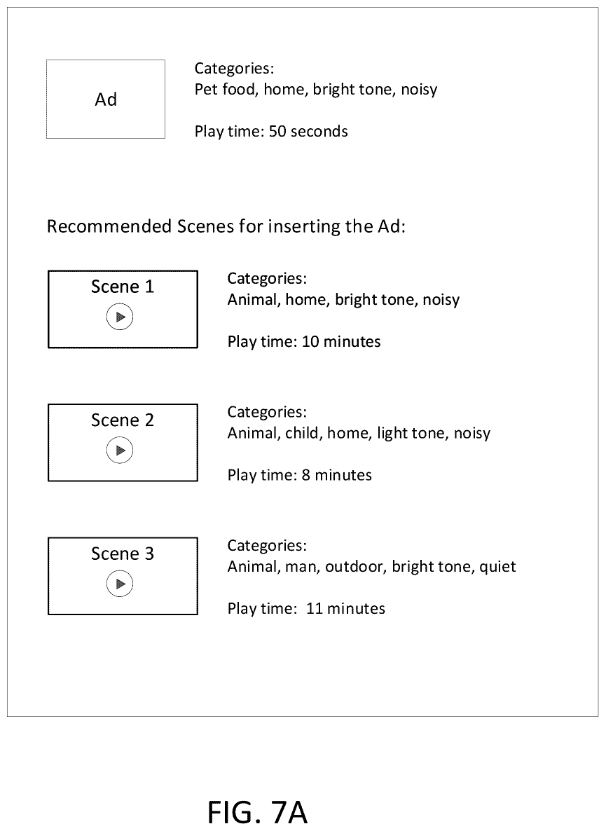

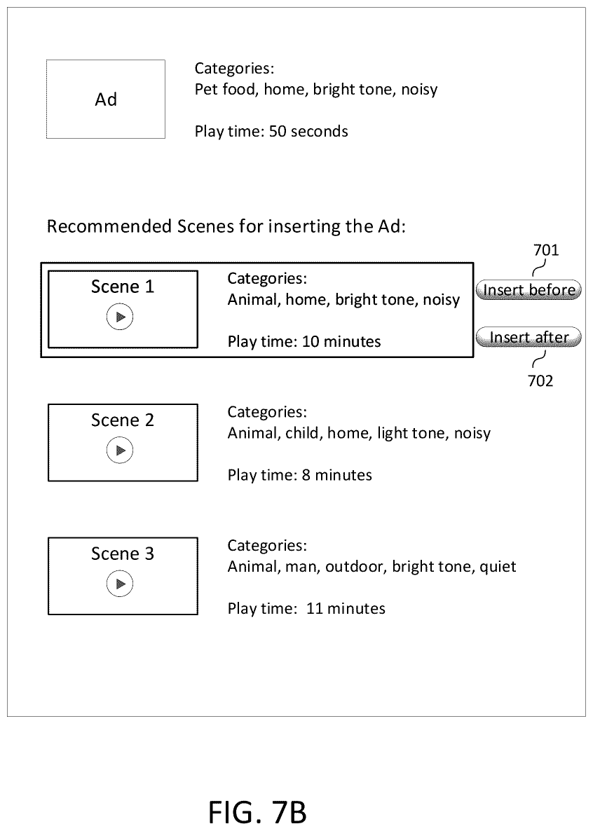

FIG. 5 shows example applications for segmented scenes. With automatically identified scene boundaries, a large number of movies or TV shows may be segmented into scenes. These segmented scenes or videos may provide basis for statistics, searching, selective viewing, pausing, comparing, etc. with improved accuracy, convenience, and comfort for viewers. The example applications may comprise video preview thumbnails, scene search, short video clip, ad insertion, similar scene identification, popular scene identification, etc. For example, a video preview thumbnail may be generated by combining a few seconds of video clips from several major scenes. These applications may be performed manually and/or automatically. The segmented scenes may be categorized. For example, the segmented scenes may be tagged with actor names, and a user may search scenes using actor names. For example, the user may input the name “Tom Cruise” in a search box, and all scenes (e.g., in a particular movie) that involve the actor Tom Cruise may appear in the search result. The scenes may be searchable using any other search terms such as scene type (e.g., fight scene, sex scene, etc.), main character type (e.g., man, woman, child, animal, etc.), main background type (e.g., city, grassland, water, outer space, or more detailed ones such as restaurant, school, etc.), scene tone (e.g., dark, bright, etc.), sound level (e.g., noisy, quiet, etc.), and/or so on, as long as these search terms or categories have been built into a database of scenes (e.g., tagged to each scene). The categorization of segmented scenes may be performed manually and/or automatically using existing image/sound recognition/classification technologies. A video clip like the well-known restaurant scene from the movie When Harry Met Sally may be easily located and separately presented as needed. For another example, ads (or advertisements, secondary content item) may be conveniently inserted immediately before or immediately after a scene without causing much visual disturbance to a viewer. Compared to seeing an ad in the middle of a scene, seeing an ad after a scene completes may make a viewer feel more comfortable and less disturbed. If scenes are categorized, it may be possible to determine one or more recommended scenes to insert ads after, before, and/or between the scene(s) in an automatic manner. For example, scenes with categories that may be related or beneficial to a particular ad may be identified. For example, if an ad is about pet food, scenes tagged with the category of animal may be identified as recommended scenes for following with the ad. If an ad has a bright tone, scenes tagged with the category of dark tone may be selected as recommended scenes for following with the ad, to get an effect of visual contrast. FIG. 7A and FIG. 7B show example interfaces for presenting recommended scenes for ad insertion. In FIG. 7A, a user may click to view the recommended scenes and may manually select a scene. In FIG. 7B, a selected scene may be highlighted, and there may be one or more buttons (e.g., buttons 701 and 702) appearing next to the highlighted scene for the user to activate ad insertion (e.g., insertion before or after the selected scene). Alternatively, the button(s) may be omitted and a scene may be automatically selected and/or an ad may be automatically inserted without interaction with a user. Primary content item like movies or TV shows with added secondary content item like ads may be outputted (e.g., transmitted) for sale, streaming, or other uses. Segmented and/or categorized scenes may also provide convenience for identifying similar scenes and/or popular scenes. For example, scenes tagged with the category of pier may comprise similar scenes like those in the movies Dark City and Requiem for a Dream. For example, popular scenes may be identified by the number of times that these scenes have been rewound for repeated watching. Similar, least popular scenes may be identified by the number of times they have been fast-forwarded by viewers.

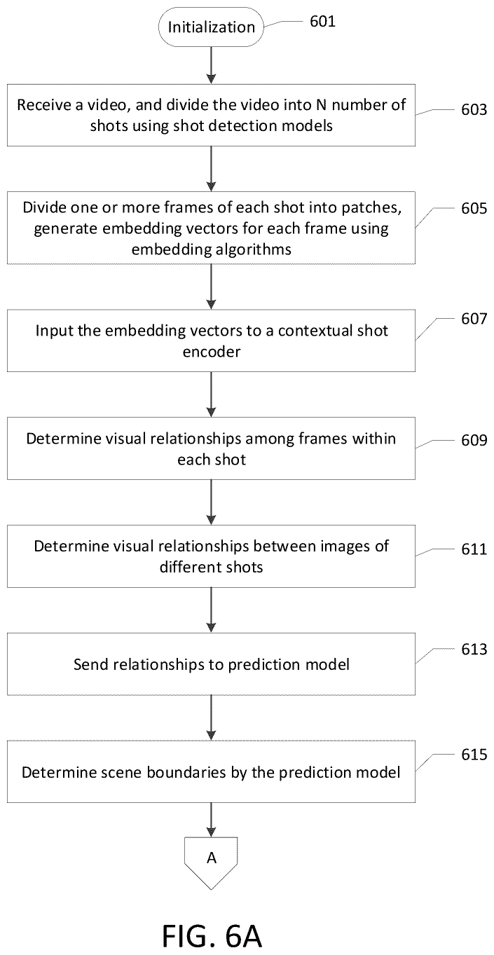

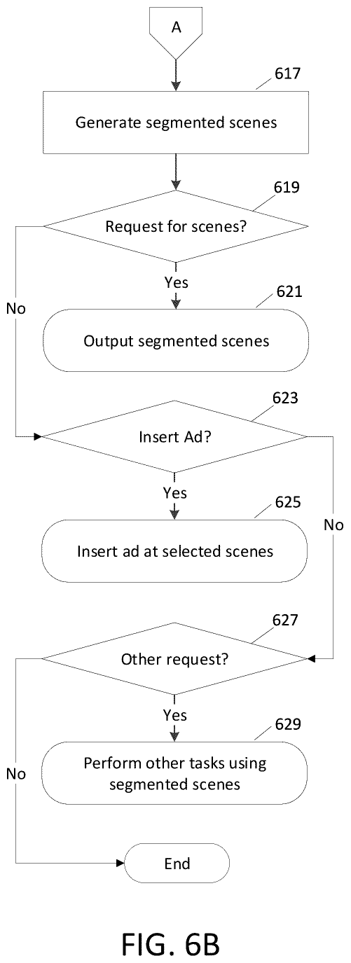

FIG. 6A is a flow chart showing an example method for segmenting scenes. The example method may be performed by any device, such as the computing device 200, video processing server 122, etc.

In step 601, a computing device (e.g., the video processing server 122) may be initialized. For example, the contextual shot encoder 400 and the prediction model 430 may be loaded and ready for performing scene segmentation for videos.

In step 603, a video (e.g., a movie 300) may be received. The video may be uploaded, downloaded, transferred, or otherwise inputted to the computing device. The video may comprise multiple frames (e.g., frames 301a-n). A movie may have tens of thousands or even millions of frames. Inputted frames may be independent frames among the frames of each GOP (see descriptions above with respect to FIG. 4A), to reduce workload of the computing device. These inputted frames (e.g., a sequence of frames) may be divided into N number of shots (consecutive or sequential shots, e.g., Shot 1, Shot 15, Shot 16, Shot 25 in FIG. 3) using existing shot detection models. Inputted frames may be processed as a whole or in batches (e.g., 9, 17, 25, or 33 shots at a time), in at least some of subsequent steps as will be described below.

In step 605, one or more frames of each shot may be divided into a plurality of patches or image portions (e.g., P1, P2, P3, P4 in FIG. 4A). These patches may produce embedding vectors (e.g., embedding vectors 412) through embedding algorithms such as linear projection, patch embedding, and positional embedding, as described previously. These embedding vectors contain information about the frames and serve as input data for further processing by machine learning models (e.g., self-attention model, etc.).

In step 607, the embedding vectors may be inputted to the contextual shot encoder 400. The contextual shot encoder 400 may comprise a plurality of model pairs connected in series (e.g., the S4A blocks 401a to 401n in FIG. 4C). Each model pair (e.g., the S4A block 401a in FIG. 4A) may comprise a self-attention model and a gated S4 model, as described above. Each model pair may also comprise supplemental layers such as normalization layer, MLP layer, as described above with respect to FIG. 4B.

In step 609, visual relationships among frames within each shot may be determined. For example, in each model pair, a first output (e.g., output data 414) may be generated. The first output may comprise data representing visual relationships within each shot. The first output may focus on identifying visual relationships (e.g., similarities, positional relationships) within the frames of each shot (e.g., between the patches of the same frame and/or of different frames). The first output may be generated, for example, by using the self-attention model, as well as the supplemental layers. The visual relationships may be represented by numbers of weights for image portions of frames in each shot. These numbers may be in a matrix form as exemplified above with respect to FIG. 4A. The first output may be inputted to another model in the same model pair for further processing.

In step 611, visual relationships between images of different shots may be determined. For example, in each model pair, a second output (e.g., output data 416) may be generated based on the first output. The second output may comprise data indicating visual relationships between shots. The second output may focus on identifying visual relationships (e.g., similarities, temporal cues) between frames that are in different shots. The second output may be generated, for example, by using the gated S4 model as well as the supplemental layers, based on the first output. The visual relationships may include visual similarities, temporal cues (e.g., actions, events, or activities that occur over time), etc. For example, information indicating a positional relationship of a common object (e.g., person, object, etc.) found in sequential frames of different shots may be generated. For example, the change in positions of a person in consecutive shots may indicate that the person is moving (e.g., running). The visual relationships may be indicated by numbers of probabilities for different classes or actions (e.g., running, phone-call, etc.), as exemplified above with respect to FIG. 4A. The second output of each model pair (e.g., S4A block 401a in FIG. 4C) may be inputted to either a prediction model (e.g., prediction model 430 in FIG. 4A) or a subsequent model pair (e.g., S4A block 401b).

For example, a model pair (e.g., S4A block 401a) may be focused on background. In this model pair, the first output may comprise a matrix with attention weights on a wall (e.g., the wall as shown in frame 301a in FIG. 3). The second output may comprise a series of probability numbers on existence of this wall for consecutive shots (e.g., Shots 1-16 in FIG. 3). A subsequent model pair (e.g., S4A block 401b) may be focused on human faces. In this model pair, the first output may comprise a matrix with attention weights on a main character's face profile (e.g., the face profile as shown in frame 301a). The second output may comprise a series of probability numbers on similarities of the face profile for the Shots 1-16. Each of the model pairs (e.g., S4A blocks 401a-401n in FIG. 4C) may have its own first output and second output, similar to the first and second outputs as described above. As these model pairs are connected in series, the first outputs and/or second outputs may comprise (e.g., be added with, or accumulate) more and more information (e.g., identified features, temporal cues, etc.) as they go through each model pair. For example, in FIG. 4C, the second output from the third model pair (e.g., S4A block 401c) may comprise not only numbers indicating features and temporal cues of an object (e.g., the shade as shown in frame 301a), but also numbers indicating features and temporal cues of the wall and the face profile as added in the previous model pairs (e.g., S4A blocks 401a and 401b). This data accumulation may continue for the rest of the model pairs. With such multiple model pairs (e.g., S4A blocks), a plurality of different self-attention models are able to be applied to frames of shots and to focus on different types of visual features. Similarly, a plurality of gated S4 models may be applied to focus on different types of temporal cues.

In step 613, the determined visual relationships may be provided (e.g., sent) to a prediction model. For example, the second output from the last model pair (e.g., the S4A block 401n) may be inputted to a prediction model (e.g., prediction model 430). As described above, the second output from the last model pair may comprise data indicating contextual information on person, object, background, etc. of each shot. The last second output may be called feature vector (e.g., feature vector 418) and may be used as basis for the prediction model 430 to make determinations on scene boundaries. For example, consecutive Shots 1-16 may have gone through all the model pairs (e.g., S4A blocks 401a to 401n). The last second outputs (e.g., the feature vectors 418) may comprise numbers indicating that a person's face, a wall, a shade, etc. consistently exist in Shots 1-15 but are missing in Shot 16. The prediction model 430 may determine that Shot 15 is a scene boundary.

In step 615, the prediction model may determine scene boundaries, for example, based on the last second output (e.g., the feature vectors 418). As described above, the prediction model may determine if a shot is a scene boundary or not, based on contextual information indicating inter-shot relationships such as temporal cues, similarities with adjacent shots, etc. The various correspondences between shot information and scene boundaries may be learned by pretraining the prediction model. The pretraining may be performed using a large quantity (e.g., 1,000) of movie videos by using computer algorithms to generate possible scene boundaries (e.g., pseudo scene boundaries) as a training reference. For example, a state-of-art Dynamic Time Warping (DTW) based pseudo boundary detection algorithm may be used to generate pseudo-boundary labels for unlabeled movie videos. The pseudo-boundary labels may be used as a supervisory signal to train the prediction model using unlabeled video for the scene boundary detection task. The pretrained model may further be finetuned by using a smaller quantity (e.g., 60) of movie videos with labels for scene boundaries (e.g., manually labeled).

FIG. 6B is a flow chart mainly showing an example method for using segmented scenes. The example method may be performed by any device, such as the computing device 200, video processing server 122, application server 107, etc.

In step 617, segmented scenes may be generated based on determined scene boundaries in step 615. For example, existing video editing technologies may be used to extract scenes at scene boundaries. These extracted scenes may be labeled with titles, and/or categorized, and may be saved in designated locations.

In step 619, it may be determined if there is a request for one or more scenes. For example, a user may want the restaurant scene from the movie When Harry Met Sally for viewing, sharing, demonstrating, or any other uses. For another example, a user may request for all the scenes that have the actor Tom Cruise in them from a listing of scenes in a Mission: Impossible movie. If it is determined that there is a request for one or more scenes, in step 621, selected segmented scenes may be outputted using any available methods. If no, the method may continue to step 623. For example, the determination may be based on detection of customer requests, either manually or automatically.

In step 621, one or more scenes may be outputted, for example, in an electronic form online, in a cloud, using digital storage means such as discs, and/or using any available methods for video delivery. The one or more scenes may be selectively or controllably played back based on the segments.

In step 623, it may be determined if the segmented scenes are to be used for ad insertion. If it is determined that ad insertion is not needed, further determination may be made in step 627 for other tasks or requests for the segmented scenes. If it is determined that ad insertion is needed, in step 625, one or more ads may be inserted at selected scenes.

In step 625, the ad may be inserted at one or more selected scenes, automatically or manually. An interface may be created so that the user may operate for the ad insertion, for example, by manually drag an ad to a desired position among the scene boundaries. In the automatic situation, ads may be inserted automatically in batches to make a plurality of pre-processed videos with commercials. Ads may also be inserted as a video is being streamed. For example, a local virtual gateway (e.g., VCMTS or virtual cable modem termination system) may have computing devices that identify scene boundaries and insert ads for at least part of a video in real time, before that part of video reaches a target viewer. The ad insertion may use any existing video insertion functions or technologies.

In step 627, it may be determined if there are other tasks or requests for the segmented scenes. For example, a preview thumbnail for a selected segmented scene may be requested. If it is determined that no other task or request exists, the process may end.

In step 629, other tasks may be performed using the segmented scenes. For example, a scene may be processed using an existing video editing software to extract selected shots and combine these shots into a thumbnail video.

The modules and models such as machine learning models (e.g., self-attention model, gated S4 model, prediction model, etc.) in this application may be executed by one or more processors of one or more computing devices. For example, these modules and models may be implemented either on a same computing device or different computing devices. These machine learning models may be trained by using one or more datasets of annotated videos. These datasets may be available online, for example, the MovieNet-SSeg dataset (https://movienet.github.io/). These datasets may also be manually compiled from a plurality of videos (e.g., movies). The training methods using annotated videos are known in this field and will not be described in detail. Alternatively or as a supplement, un-labelled movies or videos may also be used for pretraining the machine learning models, assisted by e.g. DTW algorithm, as described above.

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the disclosure. Accordingly, the foregoing description is by way of example only, and is not limiting.

1. A method comprising:
receiving, by a computing device, a sequence of frames of a primary content item;
identifying, based on comparing images of sequential frames of the sequence of frames, a plurality of shot boundaries in the sequence of frames;
determining, based on the plurality of shot boundaries, the frames into a plurality of shots;
generating, based on applying a first model to frames of each of the plurality of shots, information indicating areas of attention in the frames of each of the plurality of shots;
generating, based on applying a second model to the information indicating the areas of attention, information indicating inter-shot relationships between frames of different shots of the plurality of shots;
determining, based on the information indicating inter-shot relationships, that one or more of the shot boundaries are scene boundaries in the primary content item.

2. The method of claim 1, wherein the applying the first model to frames of the shot comprises:
dividing a frame into a plurality of patches; and
identifying visual similarities between the patches of the frame.

3. The method of claim 1, wherein the applying the first model to frames of the shot comprises:
dividing a frame into a plurality of patches; and
identifying positional relationships between patches, of the frame, that comprise visual similarities.

4. The method of claim 1, wherein the applying the first model to frames of the shot comprises:
dividing each frame, of a plurality of frames in a first shot, into a plurality of patches; and
identifying visual similarities between patches of different frames in the first shot.

5. The method of claim 1, wherein the applying the first model to frames of the shot comprises:
dividing each frame, of a plurality of frames in a first shot, into a plurality of patches; and
identifying positional relationships between patches that:
are visually similar; and
are of different frames in the first shot.

6. The method of claim 1, further comprising:
using the second model to generate information indicating a positional relationship of a common object found in sequential frames of different shots.

7. The method of claim 1, further comprising applying a plurality of different first models to the frames of the shot, wherein the different first models are configured to focus on different types of visual features; and
wherein each of the different first models is configured to provide output to a corresponding second model.

8. The method of claim 1, further comprising:
using a first pair of a first model and a corresponding second model to focus on faces; and
using a second pair of a first model and a corresponding second model to focus on objects.

9. The method of claim 1, further comprising using the scene boundaries to generate different video segments of the content item.

10. The method of claim 1, further comprising:
adding a secondary content item to the primary content item at a location that is based on one of the scene boundaries; and
causing transmission of a modified primary content item comprising the added secondary content item.

11. A method comprising:
receiving, by a computing device, a sequence of frames of a primary content item;
determining the frames into a plurality of shots based on shot boundaries;
generating information, based on applying a plurality of model pairs to frames of each of the plurality of shots, wherein each model pair comprises:
a first model configured to identify areas of attention within a frame; and
a second model configured to determine, based on the areas of attention, inter-shot relationships between frames of different shots.

12. The method of claim 11, wherein the first model is configured to identify areas of attention among a plurality of patches divided from the frame.

13. The method of claim 11, wherein the second model is configured to generate information indicating a positional relationship of a common object found in sequential frames of different shots.

14. The method of claim 11, wherein the plurality of model pairs are configured to focus on different types of visual features.

15. The method of claim 11, further comprising:
using a first model pair to focus on faces; and
using a second model pair to focus on objects.

16. The method of claim 11, further comprising:
adding a secondary content item to the primary content item at a location that is based on a scene boundary that is determined based on the inter-shot relationships determined by second models of the model pairs; and
causing transmission of a modified primary content item comprising the added secondary content item.

17. A method comprising:
receiving, by a computing device, intra-shot information indicating areas of attention in frames of each of a plurality of shots of a content item;
generating, based on the intra-shot information, inter-shot information indicating visual relationships between frames of different shots of a same content item; and
sending the inter-shot information to a prediction model for identifying scene boundaries within the content item.

18. The method of claim 17, further comprising applying a self-attention model to the frames of the content item, and providing output from the self-attention model to a gated state space model.

19. The method of claim 17, further comprising applying a plurality of different self-attention models to the frames of the content item, wherein the different self-attention models are configured to focus on different types of visual features; and
wherein each of the different self-attention models is configured to provide output to a corresponding gated state space model.

20. The method of claim 17, further comprising executing, by the computing device, the prediction model to use the scene boundaries to generate segments of the content item, and to control playback of the content item based on the segments.
